(19) United States
(12) Patent Application Publication
(10) Pub. No.: US 2011/0215177 A1
(43) Pub. Date: Sep. 8, 2011

(54) INJECTION NOZZLE

(75) Inventors: Noureddine Guerrassi, Vineuil (FR); Laurent Doradoux, Herbault (FR); Christophe Garsi, Le Blanc-Mesnil (FR); Cyrille Lesieur, Courbouzon (FR)

(73) Assignee: DELPHI TECHNOLOGIES HOLDING, S.ARL, BASCHARAGE, LU (LU)

(21) Appl. No.: 13/128,946

(22) PCT Filed: Nov. 12, 2009
(86) PCT No.: PCT/EP09/65070

§ 371 Date: May 12, 2011

(30) Foreign Application Priority Data
Nov. 14, 2008 (EP) 08169097.6

(51) Int. Cl. F02M 61/18

(52) U.S. Cl. 239/533.12

(57) ABSTRACT

An injection nozzle for injecting a fluid, the injection nozzle including a nozzle body and a nozzle hole defining a flow passage for fluid, the flow passage including passage walls and the nozzle hole having an inlet in fluid communication via the flow passage with an outlet wherein, the inlet is larger than the output and for at least one section through the inlet and outlet along the flow passage that the nozzle hole is defined, for all distances x within a substantial length of the flow passage, by the condition: |(dS/dx)|>45 microns/millimeter, where S=passage wall separation and x is the distance from the inlet.

### CROSS-REFERENCE TO RELATED APPLICATION

This application claims the benefit under 35 U.S.C. §371 of PCT Patent Application Number PCT/EP2009/065070, filed Dec. 11, 2009, the entire disclosure of which is hereby incorporated herein by reference.

### FIELD OF THE INVENTION

The present invention relates to an injection nozzle. In particular, the present invention relates to the formation and profile of an improved nozzle for the injection of a fluid from an internal nozzle volume into an external volume. The invention has particular application to fuel injection systems but may be applied to any device that utilizes a nozzle arrangement to inject a fluid from a first volume to a second volume.

### BACKGROUND TO THE INVENTION

For internal combustion engines that use direct injection, fuel is typically injected from an injection nozzle which utilizes multi-hole nozzle design in which each individual hole (nozzle outlet) has an internal geometry that has been precision manufactured from dedicated tooling. This internal hole geometry is defined and optimized in order to reach an efficient liquid fuel atomization allowing a rapid fuel and air mixture within the combustion chamber. Such optimization leads to lower exhaust emissions, optimized combustion noise, and lower fuel consumption.

Prior efforts to improve fuel/air mixing have included rounding of the hole entry orifice, the understanding being that rounding of the hole entry increased the nozzle discharge coefficient, thereby increasing the spray momentum and leading to better fuel mixing within the combustion chamber. Rounding of this type was achieved using a paste with abrasive particles but this had the disadvantage of being a lengthy manufacturing process which impacted upon the overall manufacturing cost for the injection nozzle.

More recently (see, for example, Applicant's EP0352926, EP1669157 and EP1669158) it has been suggested that the use of tapered holes gives equivalent nozzle efficiency performances (compared to injection nozzles with rounded hole orifices) while reducing the manufacturing process time and cost. The tapered hole angle (convergent) has, in the past, been characterized by a factor (kfactor) defined as follows:

kfactor=(Din−Dout)/10 Eq. 1

where Din and Dout are respectively the inlet and outlet nozzle orifice diameters given in microns (μm).

Production injection nozzles currently available have typical kfactor values of between 1 and 2.5, which equates to a reduction of hole diameter between the hole inlet and the hole outlet of 10 to 25 μm (typically, the length of the nozzle hole itself is 1 mm=1000 μm). It is noted that these kfactor values have been determined through existing knowledge of the physical processes involved in injection and also by current manufacturing equipment arrangements.

Nozzle hole efficiency may be characterized by a nozzle discharge coefficient Cd which is calculated using the Bernoulli formula as:

Cd=Q/(Sout*((2*(Pin−Pout)/ρ)̂0.5) Eq. 2

where Q is the measured hole flow rate, Pin and Pout are respectively inlet and outlet hole pressure (fuel injection pressure and back pressure which could be combustion chamber gas pressure), Sout is the hole outlet section and ρ is the liquid fuel density at the inlet hole pressure and temperature conditions.

Cd values for automotive applications typically are measured during manufacture as being between 0.80 and 0.88 (for nozzle upstream and downstream pressures of 101 bar and 1 bar respectively) and it is noted that current, known hole designs do not provide for nozzle hole discharge coefficients of more than 0.88.

A further factor in the design of nozzle holes is the accuracy to which the hole needs to be manufactured in order for the nozzle hole to operate effectively. In this regard it is noted that holes designed with kfactor values of between 1 and 2.5 are sensitive to the length of the hole such that variations in hole length can potentially adversely affect the performance of the injection nozzle. As a consequence the machining of nozzle holes in current injection nozzles requires a high degree of accuracy which results in lengthy and costly manufacturing processes.

It is therefore an object of the present invention to provide an injection nozzle that overcomes or substantially mitigates the above-mentioned problems.

### SUMMARY OF THE INVENTION

According to a first aspect of the present invention there is provided an injection nozzle for injecting a fluid, the injection nozzle comprising: a nozzle body and a nozzle hole defining a flow passage for fluid, the flow passage comprising passage walls and the nozzle hole having an inlet in fluid communication via the flow passage with an outlet, wherein, the inlet is larger than the outlet and for at least one section through the inlet and outlet along the flow passage the nozzle hole is defined, for all distances x within a substantial length of the flow passage, by the condition:

|(dS/dx)|>45 microns/millimeter Eq. 3

where S=passage wall separation and x is the distance from the inlet.

The present invention provides for an injection nozzle with a tapered injection hole (the inlet being larger than the outlet) that has a far greater level of tapering than in conventional nozzle designs. In particular it is noted that if a slice (section) is taken along the length of the hole then, for a substantial portion of that section, the condition |dS/dx| (i.e. magnitude of the rate of change of wall separation (opposing internal hole walls) with distance) will be greater than 45 microns per millimeter for all distances x within that substantial portion.

In other words the magnitude of the condition (dS/dx) (or |(dS/dx)|) at any given distance x along a substantial portion of the nozzle hole is greater than 45 microns per millimeter. It is noted that the profile of the passage walls within the section may be linear. Alternatively the profile of the walls may be parabolic or otherwise curved or a mixture of sections of curved and linear profile. Within the section through the hole however the minimum value of the condition, along a substantial portion of the length of the hole, always exceeds 45 microns per millimeter, i.e. |(dS/dx)|>45 μm/mm.

It is noted that compared to traditional nozzle hole designs, injection nozzles in accordance with embodiments of the present invention demonstrate improved discharge coefficients, better fuel atomization performance and improved pressure and velocity flows within the hole itself. It is also noted that in traditional hole designs which incorporate hole rounding the local wall separation values may exceed the wall condition stated above. However, this occurs over an extremely localized part of the traditional nozzle hole and is in contrast to the present invention in which the wall condition holds along a substantial length of the hole's length.

An injection nozzle in accordance with an embodiment of the present invention may be used in a fuel injection system such as those described in the Applicant's patent applications EP0352926, EP1669157, EP1669158, EP1081374, EP1180596, EP1344931, EP1496246, EP1498602, EP1522721, EP1553287, EP1645749, EP1703117, EP1744051 and EP1643117. However, it is noted that the present invention is applicable to any fluid delivery system where a fluid is injected from a first volume to a second volume.

Preferably, the nozzle hole is defined, at any given x along a substantial length of the hole, by the condition |(dS/dx)|>60 μm/mm. It is noted that a nozzle hole satisfying this condition exhibits around a 5% performance increase based on an analysis of the discharge coefficient Cd compared to known tapered injection holes.

Preferably, the nozzle hole is defined, at any given x along a substantial length of the hole, by the condition |(dS/dx)|>80 μm/mm. It is noted that such a condition reduces the effects of variations in the length of the injection hole on its performance. A nozzle hole satisfying such a condition will not therefore need to be manufactured to such high manufacturing tolerance levels as for current injection holes.

Conveniently, it is noted that the improved performance of nozzle holes in accordance with embodiments of the present invention is observed when the wall condition holds for at least 40% of the length of the hole. Preferably, the condition should hold for the final 60% to 90% of the length of the hole.

Conveniently, if the hole inlet and outlet define a nozzle hole axis then the at least one section may be taken through the axis. Conveniently, the wall separation condition may be satisfied for all sections through the axis regardless of their orientation about the axis.

Conveniently, the cross section of the nozzle hole may be circular or elliptical. Where the cross section is elliptical then sections taken through the hole axis and either the major or minor axes of the ellipse may satisfy the wall separation condition. As a further alternative, the cross section of the nozzle hole may be triangular, rectangular, square, or any other polygon.

It is noted that the nozzle body may be provided with a bore which is in communication with a source of fluid (e.g. pressurized fuel) and the injection nozzle may be arranged to inject fluid from the bore through the nozzle hole to a volume outside the nozzle, e.g. a combustion volume of an engine system. In this arrangement it is noted that the hole inlet opens into the bore and the hole outlet opens into the volume outside the injection nozzle.

Preferably, the injection nozzle comprises a plurality of nozzle holes in accordance with the nozzle hole described above and this plurality of holes may be arranged in one or more rows of holes such as those described in the Applicant's patent applications EP1645749, EP1703117, EP1744051, and EP1643117.

The passage walls of the flow passage within the at least one section may comprise linear and non-linear arrangements, e.g. the walls may form a straight line taper, a parabola, a mixture of linear and non-linear profiles etc.

The invention extends to a fuel injector for an internal combustion engine comprising an injection nozzle according to the first aspect of the present invention.

### BRIEF DESCRIPTION OF THE DRAWINGS

FIGS. 1 and 2 show sections through known fuel injector arrangements;

FIG. 3 shows a section through a typical injection nozzle outlet hole;

FIGS. 4 and 5 show known injection hole arrangements in an injection nozzle;

FIG. 6 shows sections through an injection nozzle outlet hole in accordance with an embodiment of the present invention;

FIG. 7 shows cross sections through injection nozzle outlet holes that may be used in conjunction with an embodiment of the present invention;

FIG. 8 shows a plot of discharge coefficient Cd versus hole inlet radius;

FIGS. 9a to 9j show the effects of nozzle hole taper on internal hole fluid pressure and velocity;

FIG. 10a is a plot of internal nozzle hole pressure with distance from the hole inlet;

FIG. 10b is a plot of internal fluid velocity; with distance from the hole inlet;

FIG. 10c is a plot of internal fluid velocity with distance from the hole axis;

FIG. 11a shows a plot of discharge coefficient improvement versus internal hole geometry for two nozzle holes of different lengths;

FIG. 11b shows a plot of discharge coefficient versus internal hole geometry for a first nozzle hole having no inlet rounding and for a second nozzle hole having inlet rounding;

FIGS. 12a to 12f show a comparison in internal pressure and velocity fields for known hole geometries and hole geometries in accordance with embodiments of the present invention;

FIGS. 13a to 13d show the effects of increasing hole taper on fluid exit velocity for two holes of different lengths;

FIGS. 14a to 14f show the effect of hole taper on spray penetration into the combustion volume;

FIG. 15 shows a plot of emission and particulate levels for a known hole geometry and a hole geometry in accordance with embodiments of the present invention;

FIG. 16 shows a comparison of CO2 emission levels for a known hole geometry and a hole geometry in accordance with embodiments of the present invention;

FIGS. 17a to 17d show plots of fuel consumption, filter smoke number (FSN), boost pressure and exhaust temperature for a known hole geometry and a hole geometry in accordance with embodiments of the present invention.

### DETAILED DESCRIPTION

In the following description the present invention is discussed in relation to its application to fuel injection nozzles. It is to be noted however that the present invention may be applied to any type of injection nozzle used to inject a fluid from a first volume into a second volume. For example, the injection nozzle may be used to inject liquid fuel from a supply volume into a heating/combustion chamber in a domestic heating system. Other applications for the present invention include gasoline direct injection systems and furnaces.

It is further noted that the use of the injection nozzle in accordance with embodiments of the present invention described below are not limited to any particular type of engine.

In the following description it is noted that like numerals are used to denote like features. It is also noted that the terminology Average|(dS/dx)| is used as a shorthand notation in the description below to describe the manner in which the separation of the walls of an injection hole change along the length of the injection hole. In the above expression, S relates to the separation of the walls of the injection nozzle within a section taken along the passage way formed by the injection hole and the expression is taken to mean that at any given point along the section (or at any given point along a substantial length of the hole length) the “gradient” of the wall separation will always exceed the stated value. It is noted that non-linear wall profiles are therefore included within this expression but that the minimum value of the value |dS/dx| will always exceed the stated value (even though the value may vary along the length of the injection hole or may vary along the substantial portion of the injection hole for which the condition is defined).

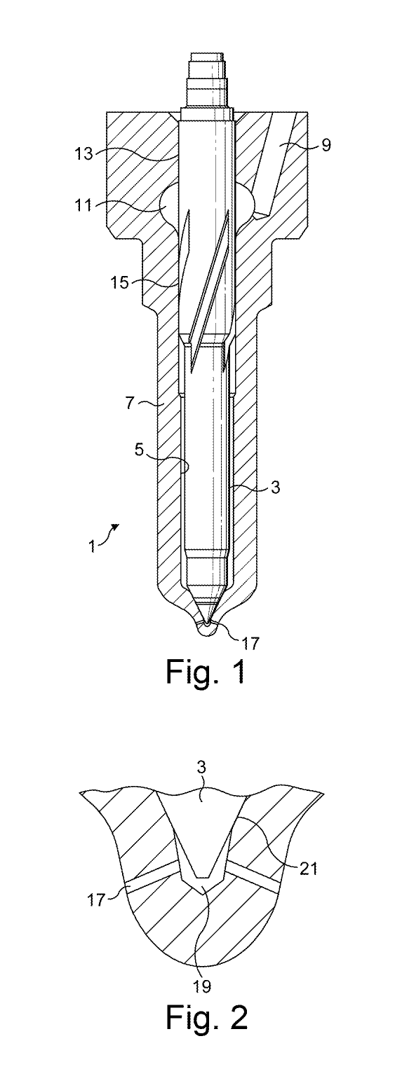

Turning to FIGS. 1 and 2, a fuel injection nozzle 1 is shown comprising an injection needle 3 located in a bore 5 of the nozzle body 7. The nozzle further comprises a feedhole 9 for the supply of fuel to a fuel gallery 11. The needle 3 is constrained to move by an upper guide 13 and lower guide 15. A series of injection holes 17 in the tip of the body 7 allow fuel to be injected from a nozzle sac 19 at the base of the injection nozzle 1 into a combustion space (not shown) when the needle lifts from its seat 21.

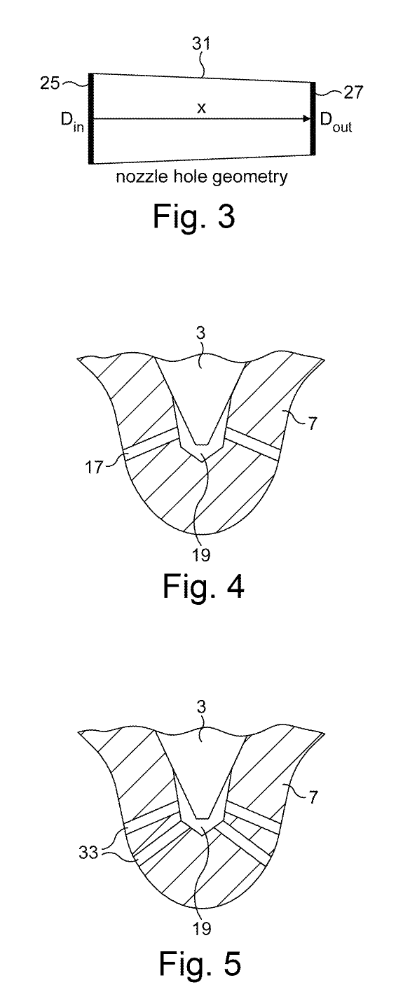

FIG. 3 shows a section through a nozzle hole. It is noted that the hole inlet 25 has a diameter Din and the hole outlet 27 a diameter Dout and that Din>Dout. It is noted that as the distance x along the hole axis 29 increases, the walls 31 of the hole converge to form a tapered internal geometry. The dimensions of FIG. 3 have been exaggerated for illustrative purposes but it is noted that typically the hole will have a length in the order of 1 millimeter (1000 μm) and the difference between Din and Dout will be in the range 10 μm to 25 μm.

FIG. 4 shows a section through an injection nozzle 1 with a single row of injection holes 17. FIG. 5 shows an alternative arrangement in which there are two rows 33 of injection holes.

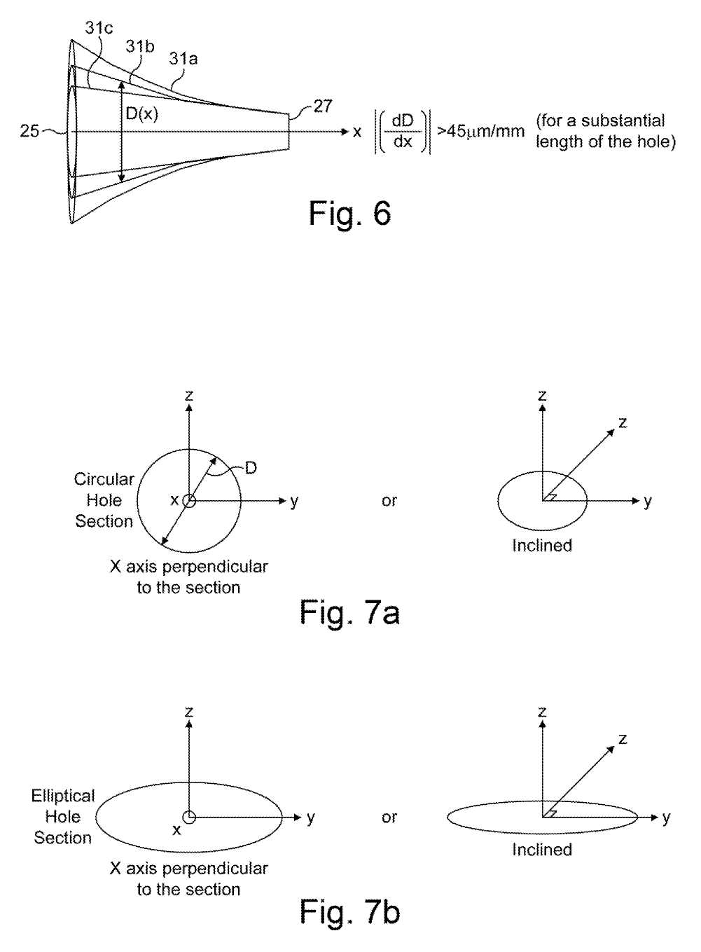

FIG. 6 shows a section through a nozzle hole 17 in accordance with an embodiment of the present invention. Three separate hole internal geometries are shown in FIG. 6 (denoted by the three wall positions 31a, 31b, and 31c). It is noted that in comparison to the injection nozzle of FIG. 3, the hole inlet 25 in FIG. 6 is significantly larger than the hole outlet 27.

In FIG. 6 the diameter, D, of the hole at a position x along the hole axis is designated as D(x) and it is noted that Average|(dS/dx)|>45 μm/mm. In other words, the minimum value of |dD/dx| along the central hole axis is >45 microns per millimeter. It is noted however that the gradient of |dD/dx| may vary along the axis such that the profile of the hole walls is non-linear.

As is described below all the various hole geometries shown in FIG. 6 provide improved injector performance in comparison to known injection nozzles if the rate of change of the hole diameter (or hole wall separation for non-circular cross sections) exceeds 45 microns per millimeter.

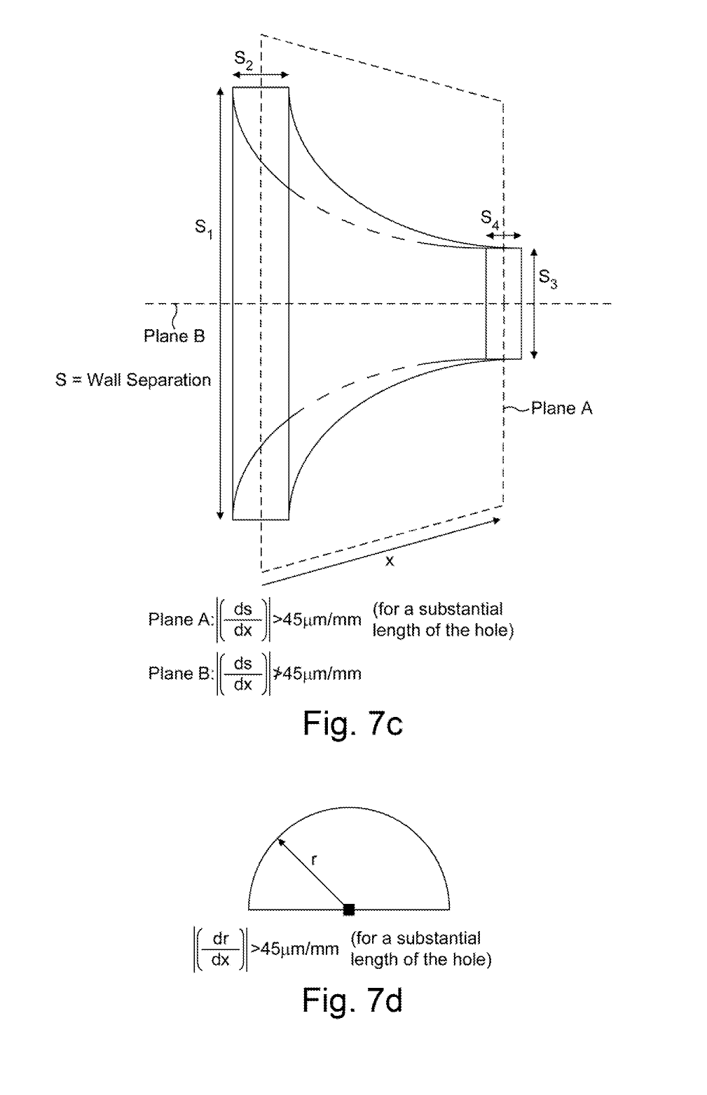

As noted above in FIG. 6, the cross sectional profile of the hole need not be circular. As shown in FIGS. 7a to 7d, circular, elliptical, rectangular and even semi-circular hole cross sections may also be used in conjunction with embodiments of the present invention as long as, for at least one section along the hole axis, the wall separation of the hole, along a substantial length of the hole, satisfies the condition that Average|(dS/dx)|>45 μm/mm, where S=wall separation.

Non-circular hole cross sections may offer performance advantages, e.g. a rectangular hole design may inject a sheet of fuel into a combustion chamber which may be preferable in certain circumstances to a jet as would be injected with a circular hole.

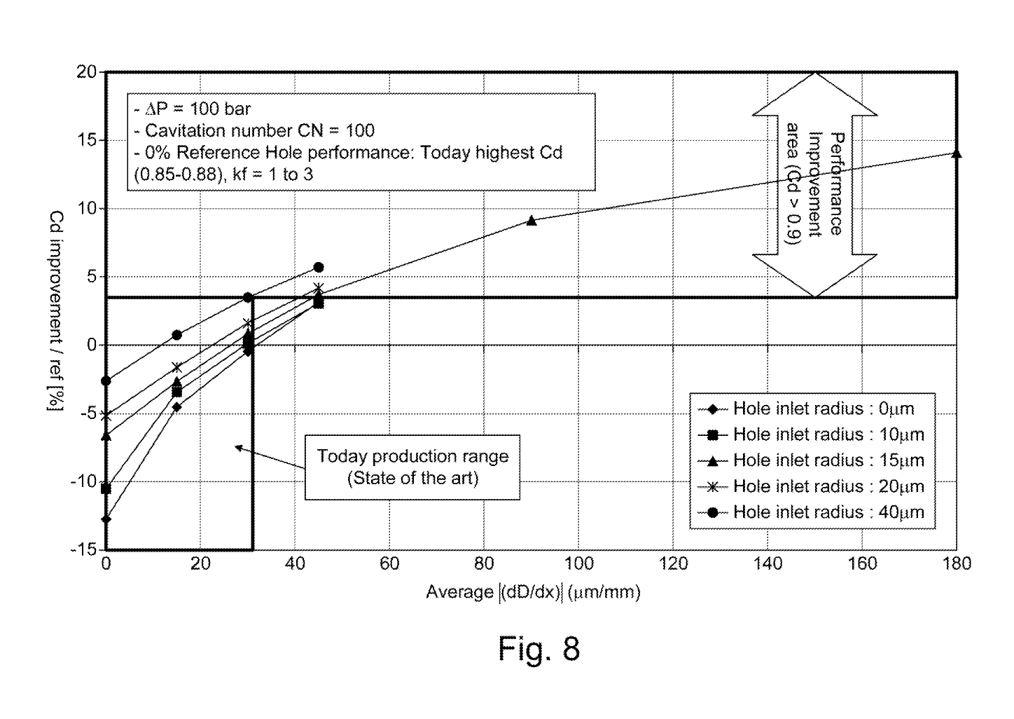

FIG. 8 shows a plot of discharge coefficient Cd versus the hole internal geometry for a circular cross-sectional nozzle hole. It can be seen that the Fig. covers internal hole geometries that vary from cylindrical (dD/dx=0) up to an extreme hole design in which the hole diameter changes by the equivalent of 180 μm per 1000 μm. Results for five different hole inlet radii are shown.

For the purposes of FIG. 8 the reference hole design equates to a discharge coefficient of between 0.85-0.88 and the y axis indicates percentage improvements relative to this design.

Current nozzle designs fall within the region indicated 50 and, for nozzle holes of length 1 millimeter, it can be seen that these hole geometries equate to a kfactor of between 0 and 3.

It can be seen from the Fig. that internal hole geometries whose wall separation increases at a rate of approximately 45 μm/mm or more show a noticeable increase in discharge coefficient compared to current designs. It is also noted that the hole taper has a greater effect on the discharge coefficient of the hole than the inlet radius (i.e. the taper has a greater effect than local rounding of the hole inlet). It is further noted that once the wall separation increases at a rate greater than 60 μm/mm, the injection nozzle demonstrates a 5% performance increase.

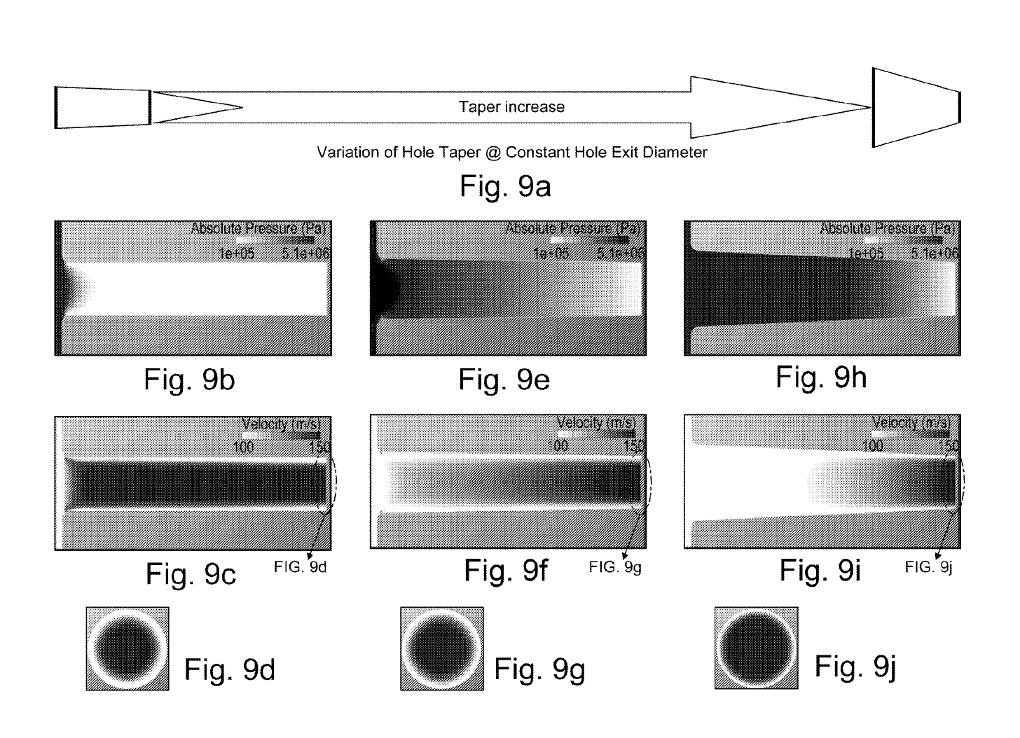

FIGS. 9a to 9j show the effects of nozzle hole taper on internal hole fluid pressure and velocity. In FIG. 9, three different hole geometries are tested and it can be seen from FIG. 9a that the hole taper increases from left to right across the Fig.. In each hole tested the exit diameter of the hole is a constant.

FIGS. 9b, 9c and 9d relate to a cylindrical hole, i.e. hole taper=0. FIG. 9b shows the internal pressure field within the hole. The area to the far left of FIG. 9b is the pressure within the bore 5 of the injection nozzle and it can be seen that for the taper=0 design there is a sudden and significant pressure drop at the inlet to the nozzle hole.

FIGS. 9c and 9d show the internal hole velocity field. FIG. 9c shows the velocity field along the axis of the hole. FIG. 9d shows the velocity field through a cross section through the hole outlet. It can be seen from FIGS. 9c and 9d that the maximum fluid velocity occurs at the hole inlet and that the maximum velocities concentrate around the hole axis. Towards the hole walls the velocity drops off towards lower values.

FIGS. 9e, 9f, and 9g relate to a tapered nozzle hole in accordance with current known nozzle arrangements, i.e. hole taper=10-25 μm/mm. FIG. 9e shows the internal hole pressure field for this hole arrangement and it can be seen that the pressure drop in the hole is more progressive than for the cylindrical hole geometry. The velocity field for this arrangement is shown in FIG. 9f and this shows a more gradual flow acceleration than for the cylindrical hole arrangement. However, as can be seen from FIG. 9g, the velocity field at the outlet is still concentrated about the hole axis.

FIGS. 9h, 9i, and 9j relate to a tapered nozzle hole in accordance with an embodiment of the present invention, i.e. hole taper=90 μm/mm (hole length=0.6 mm in this example). In FIG. 9h it can be seen that the nozzle arrangement in accordance with an embodiment of the present invention now shows a gradual pressure drop along the entire length of the nozzle hole. Furthermore, as can be seen from FIG. 9i the velocity of the fluid accelerates towards the hole outlet and from FIG. 9j it can be seen that the boundary layer in the outlet cross section is significantly thinner than in the first two hole geometries. This has the effect that the average speed of fluid exiting the hole is increased in comparison to the first two hole geometries.

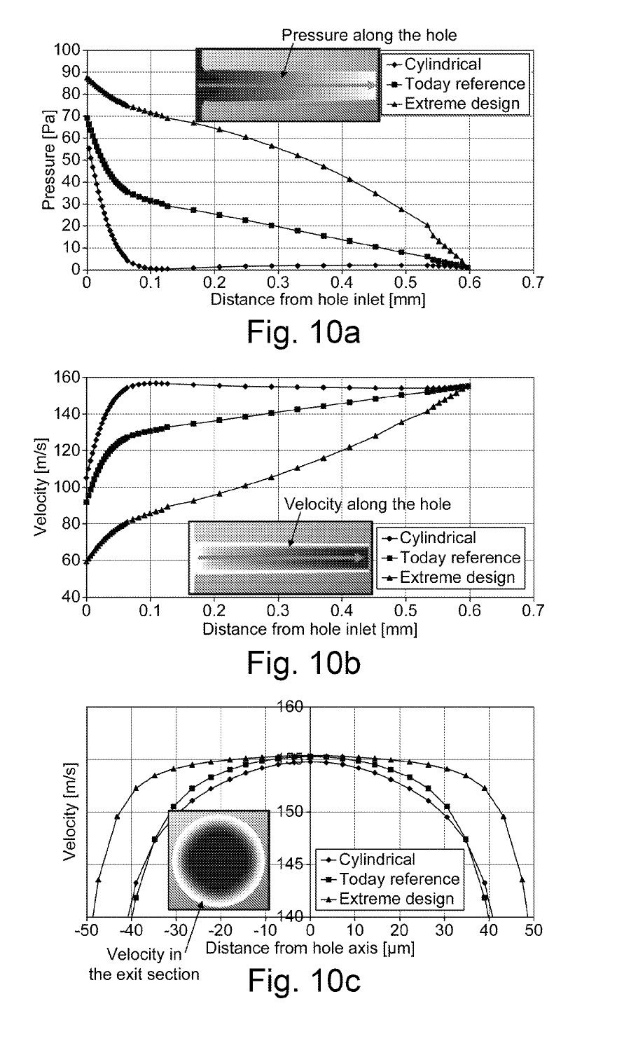

FIGS. 10a to 10c show the data from FIG. 9 in the form of graphical plots. FIG. 10a confirms that the pressure drop along the hole axis is more gradual for the hole designed in accordance with an embodiment of the present invention (labeled “extreme design” in FIG. 10a).

FIG. 10b shows that for the cylindrical and current reference hole geometries there is an initial acceleration at the hole inlet followed by an extended period of substantially constant fluid velocity. In the geometry in accordance with an embodiment of the present invention by contrast there is a gradual acceleration along the entire hole length.

FIG. 10c confirms that the fluid velocity at across the hole outlet is more uniform with a hole geometry in accordance with an embodiment of the present invention.

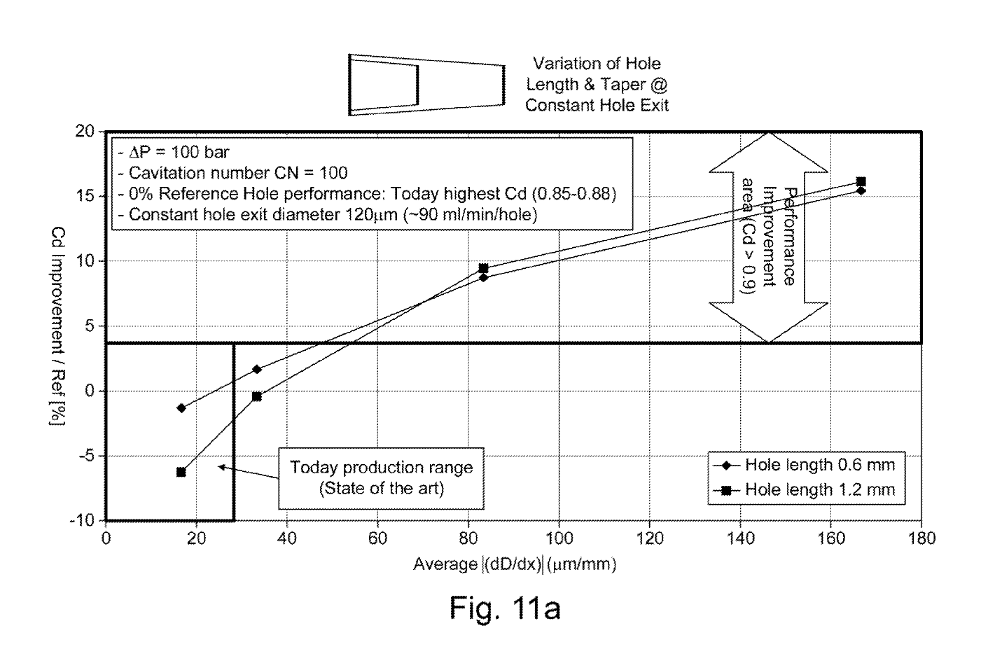

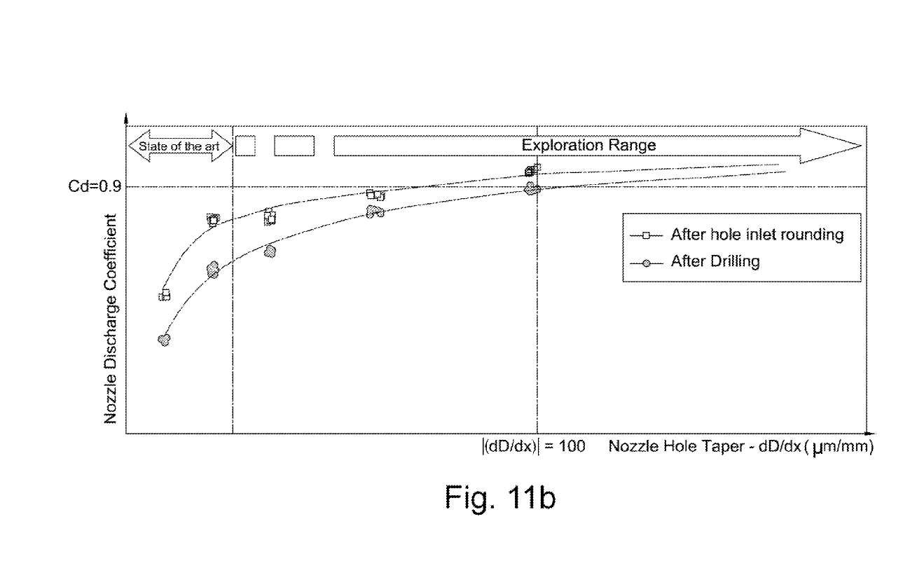

FIG. 11a shows a plot of improvement in discharge coefficient (compared to a reference geometry) versus internal hole geometry. Two separate plots are shown, the first for a nozzle hole of length 0.6 mm and the second for a nozzle hole of length 1.2 mm.

It can be seen that for hole taper values in accordance with current known production designs the length of the hole has a noticeable effect on the performance of the nozzle. However, for higher values of |dD/dx| (i.e. for values in accordance with an embodiment of the present invention) the hole length becomes less important and from a value of approximately 80 μm/mm the nozzle performance appears to be independent of nozzle hole length.

FIG. 11b a plot of discharge coefficient versus hole geometry for a hole without inlet rounding and a hole with inlet rounding. It can be seen that for lower hole taper values hole rounding is more significant than at higher hole taper values.

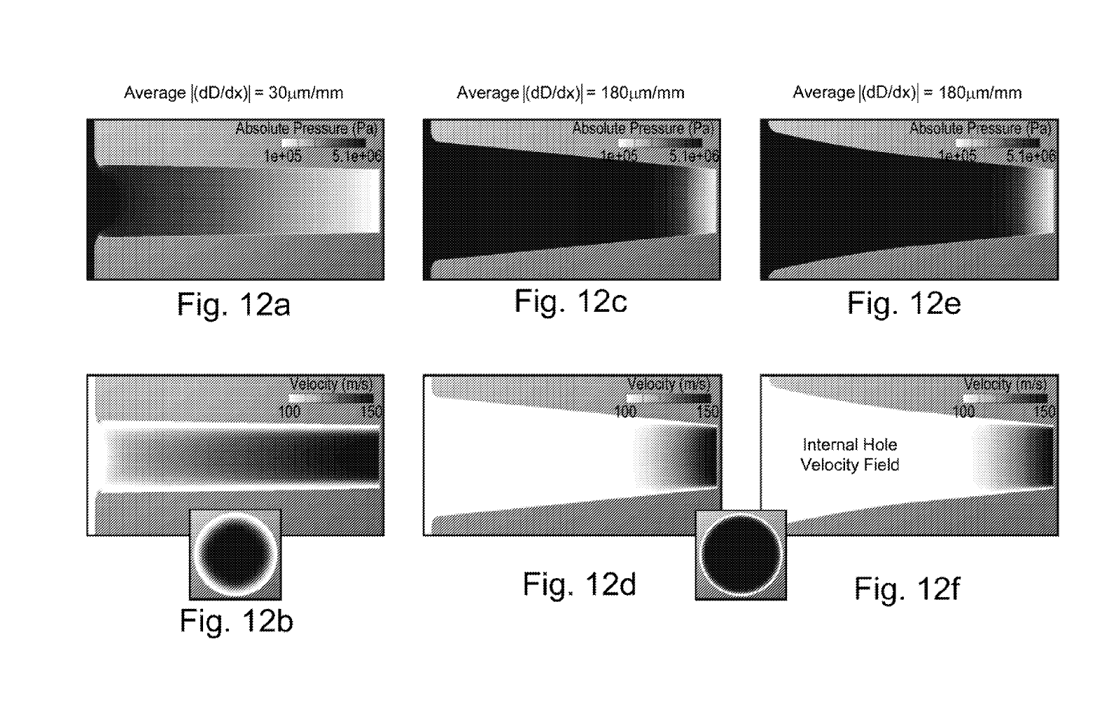

FIGS. 12a to 12f show a comparison in internal pressure and velocity fields for known hole geometries and hole geometries in accordance with embodiments of the present invention.

FIGS. 12a and 12b relate to a hole with a |dD/dx| value of approximately 30 μm/mm. It can be seen that there is a large and sudden pressure drop within the hole and the velocity field shows a large high velocity area which leads to high energy losses.

FIGS. 12c to 12f show two hole geometries with a |dD/dx| value of 180 μm/mm. FIGS. 12c and 12d relate to a hole that has a linear wall profile along the hole axis. FIGS. 12e and 12f relate to a hole that is initially parabolic in profile and then subsequently linear in profile. In both cases the |dD/dx| value is equal to or exceeds 180 μm/mm along the entire section of the hole.

It can be seen that the two hole profiles shown in FIGS. 12c to 12f exhibit similar behavior indicating that the actual profile of the hole along the axis does not affect the performance of the nozzle. In both cases it can be seen that there is a smooth discharge area and the higher fluid velocities are located in the vicinity of the hole outlet.

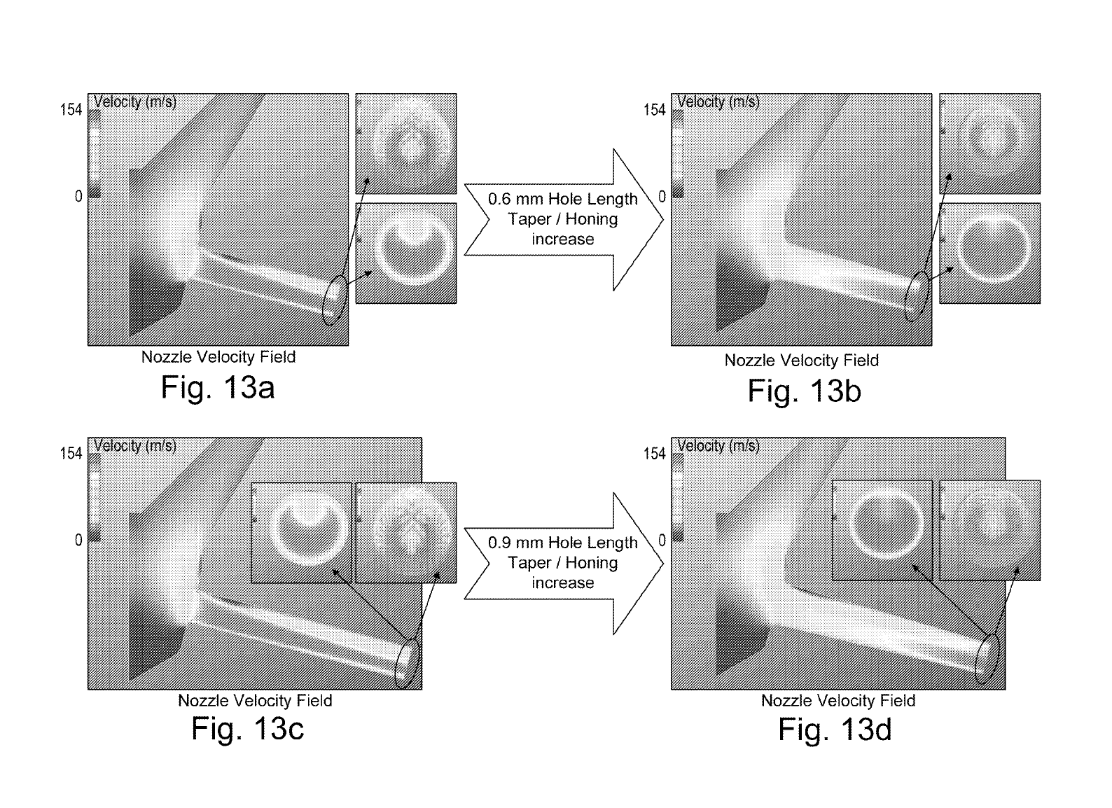

FIGS. 13a and 13b show the effect of increasing the taper of a hole of length 0.6 mm from 0 to 50 μm/mm. It can be seen from FIG. 13a that the velocity field within the hole is substantially “U” shaped. In FIG. 13b by contrast the velocity field is more uniform at the hole outlet.

FIGS. 13c and 13d show a similar velocity field plot for a hole of length 0.9 mm. Again, the increased taper geometry shows an improvement in homogenous velocity at the exit of the hole.

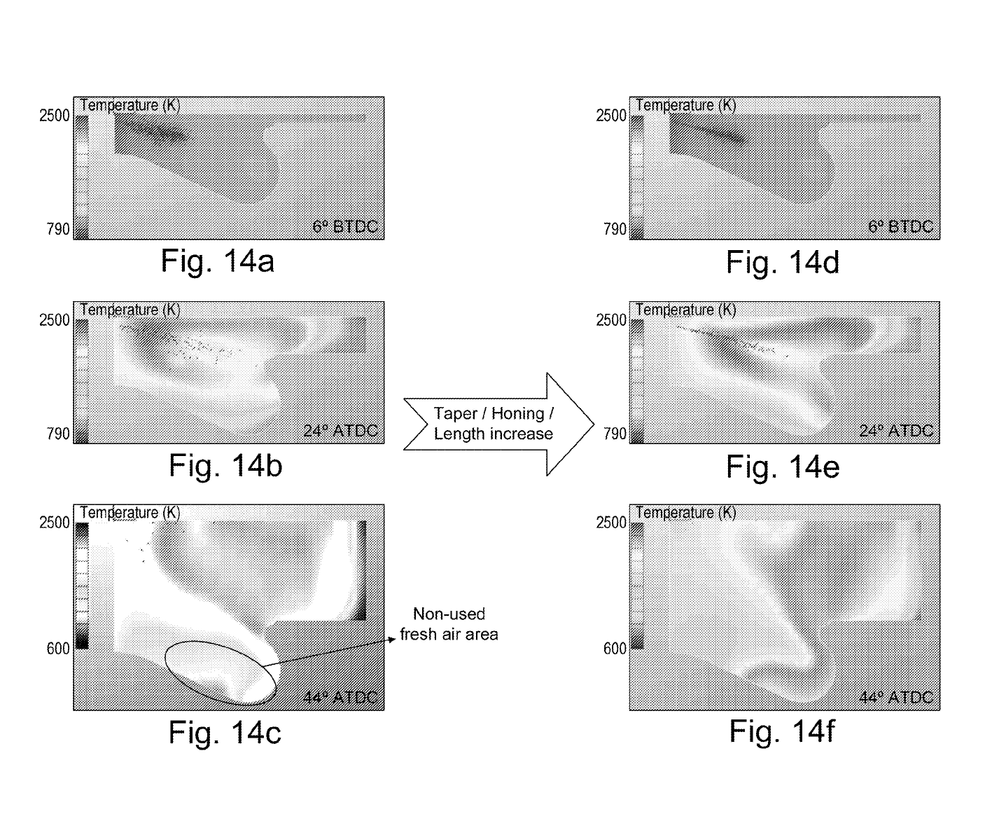

FIGS. 14a to 14f show the effect of hole taper on spray penetration into a combustion volume. FIGS. 14a to 14c show spray penetration at three different crank angles (6 degrees before top dead centre; 24 degrees after top dead centre; and, 44 degrees after top dead centre) for a cylindrical nozzle hole. It can be seen that the spray does not mix well, especially in FIG. 14c where there is an area of unused air (circled in FIG. 14c).

FIGS. 14d to 14f show spray penetration at the same three crank angles for a nozzle hole with relatively high taper (in this example the taper is 50 μm/mm). It can be seen that compared to the hole design of FIGS. 14a to 14c there is an improvement in spay penetration and mixing.

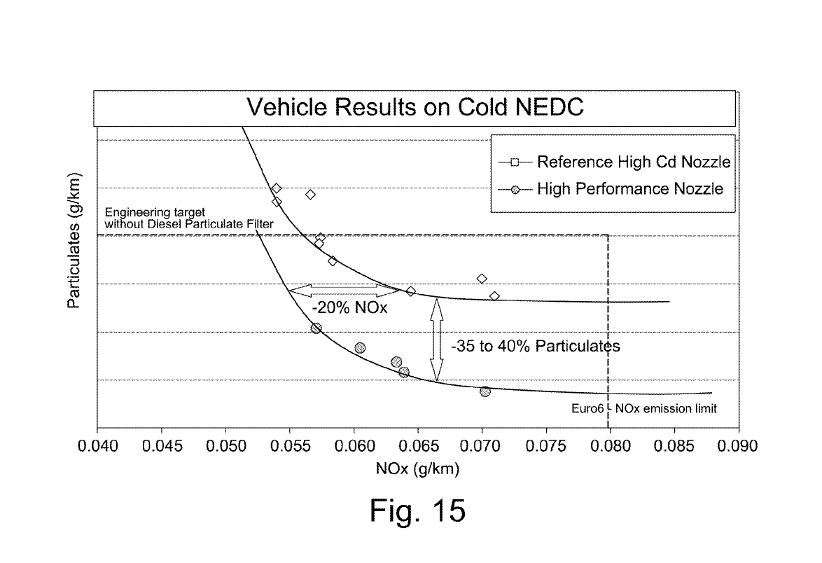

FIGS. 15, 16, and 17a to 17d show results that compare a reference hole and a high performance hole geometry. It is noted that in each case the reference nozzle comprises a design at the limit of current production values (e.g. 25 μm/mm) and the high performance nozzle comprises a hole taper of approximately 100 μm/mm. In all cases the nozzles are 6 hole nozzles.

FIG. 15 shows a comparison of particulate emissions and NOx emissions for a reference (i.e. known) nozzle design and a nozzle in accordance with embodiments of the present invention. It can be seen that the nozzle in accordance with embodiments of the present invention demonstrates a reduction of particulate emissions of up to 40% compared to the known design.

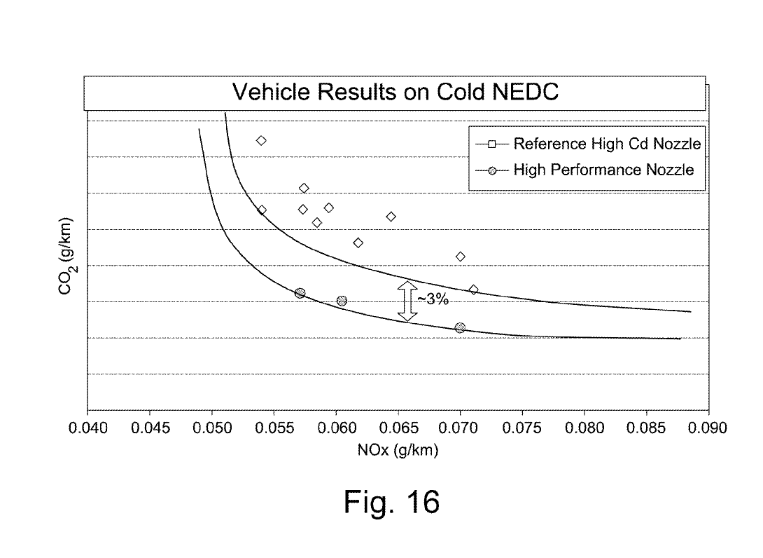

FIG. 16 shows that a reduction in CO2 emissions may also be achieved with nozzles in accordance with embodiments of the present invention in comparison to known nozzle hole geometries.

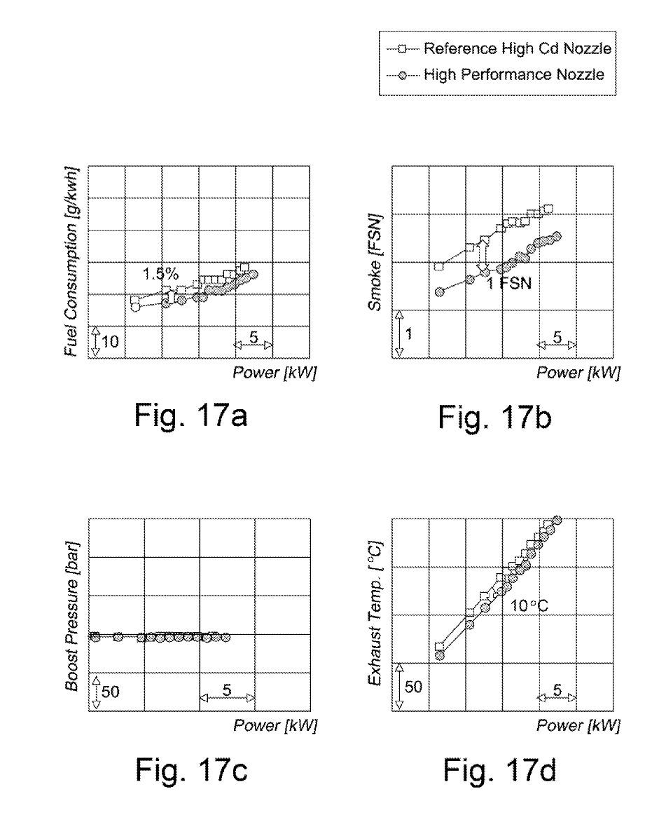

FIGS. 17a to 17d illustrate an assessment of a nozzle in accordance with embodiments of the present invention on a multi-cylinder engine operating at full load. At full load an improved global combustion efficiency was observed in comparison to known nozzle hole designs. At the same power point the engine comprising nozzle designs in accordance with the present invention demonstrated lower fuel consumption (approximately a 1.5% improvement compared to the reference system); lower smoke emissions (−1 FSN) and a lower exhaust temperature (approximately 10° C. compared to the reference system).

The present invention may be implemented in a fuel injector, such as a common rail injector, in which a common supply (rail) delivers fuel to at least one injector of the engine, or may be implemented in an electronic unit injector (EUI) in which each injector of the engine is provided with its own dedicated pump and, hence, high pressure fuel supply. The invention may also be implemented in a hybrid scheme, having dual common rail/EUI functionality.

The invention may also be implemented in any system where a fluid is injected from a first volume to a second volume.

It will be understood that the embodiments described above are given by way of example only and are not intended to limit the invention, the scope of which is defined in the appended claims. It will also be understood that the embodiments described may be used individually or in combination.

1. An injection nozzle for injecting a fluid, the injection nozzle comprising: a nozzle body defining a nozzle hole defining a flow passage for fluid, the flow passage comprising passage walls and the nozzle hole having an inlet in fluid communication via the flow passage with an outlet, wherein
the inlet is larger than the output and for at least one section through the inlet and outlet along the flow passage the nozzle hole is defined, for all distances x within a substantial length of the flow passage, by the condition |(dS/dx)|>45 microns/millimeter, where S=passage wall separation and x is the distance from the inlet.

2. The injection nozzle as claimed in claim 1, wherein the nozzle hole is defined by the condition |(dS/dx)|>60 microns/millimeter.

3. The injection nozzle as claimed in claim 1, wherein the nozzle hole is defined by the condition |(dS/dx)|>80 microns/millimeter.

4. The injection nozzle as claimed in claim 1, wherein the inlet and outlet define a nozzle hole axis and the at least one section is taken through the axis.

5. The injection nozzle as claimed in claim 4, wherein the condition is satisfied for all sections through the axis.

6. The injection nozzle as claimed in claim 1, wherein the wall condition holds for at least 40% of the length of the flow passage.

7. The injection nozzle as claimed in claim 1, wherein the nozzle hole has a circular cross section along the length of the flow passage.

8. The injection nozzle as claimed in claim 1, wherein the nozzle hole has an elliptical cross section along the length of the flow passage.

9. The injection nozzle as claimed in claim 8, wherein sections taken through either the major and minor axes or both axes of the ellipse satisfy the condition.

10. The injection nozzle as claimed in claim 1, wherein the nozzle hole has a substantially rectangular cross section along the length of the flow passage.

11. The injection nozzle as claimed in claim 1, wherein the nozzle body is provided with a bore in communication with a source of fluid and the injection nozzle is arranged to inject fluid from the bore through the nozzle hole to a volume outside the injection nozzle.

12. The injection nozzle as claimed in claim 1, wherein the nozzle comprises a plurality of nozzle holes.

13. The injection nozzle as claimed in claim 12, wherein the plurality of nozzle holes are arranged in one or more rows of holes.

14. The injection nozzle as claimed in claim 1, wherein the passage walls in the at least one section define one of a parabolic profile, a linear profile, and a mixture of curved and linear profiles.

15. A fuel injector for an internal combustion engine comprising an injection nozzle, said injector nozzle comprising a nozzle body defining a nozzle hole defining a flow passage for fluid, the flow passage comprising passage walls and the nozzle hole having an inlet in fluid communication via the flow passage with an outlet, wherein the inlet is larger than the output and for at least one section through the inlet and outlet along the flow passage the nozzle hole is defined by the condition |(dS/dx)| is greater than 45 microns/millimeter for all values of x within a substantial length of the flow passage, wherein S=passage wall separation and x is the distance from the inlet.
